(19) United States
(12) Patent Application Publication
(10) Pub. No.: US 2024/0160170 A1
(43) Pub. Date: May 16, 2024

(54) AUTONOMOUS SOFTWARE CONTROLLER ADAPTATION

(71) Applicant: RAKUTEN MOBILE, INC., Tokyo (JP)

(72) Inventors: Paul HARVEY, Tokyo (JP); Jee Chang, Leon WONG, Tokyo (JP)

(21) Appl. No.: 17/757,077

(22) PCT Filed: Apr. 5, 2022
(86) PCT No.: PCT/US2022/023461

§ 371 Date: Jun. 9, 2022

Related U.S. Application Data
(60) Provisional application No. 63/171,533, filed on Apr. 6, 2021.
(60) Provisional application No. 63/209,932, filed on Jun. 11, 2021.
(60) Provisional application No. 63/239,889, filed on Sep. 1, 2021.

(51) Int. Cl. G05B 19/042; G06F 11/34

(52) U.S. Cl. CPC G05B 19/042; G06F 11/3466

(57) ABSTRACT

Autonomous software controller adaptation is performed by generating a software controller by arranging a first sequence of modular functions according to a controller specification, the controller specification indicating a software controller input, a software controller output, and a utility function, applying an experiment to the software controller to obtain a utility value, indicating whether the software controller is a candidate controller for operation based on the utility value, and replacing an operating controller with the candidate controller in response to a condition for replacing the operating controller being satisfied.

### CROSS-REFERENCE TO RELATED APPLICATIONS

This application claims priority to U.S. Provisional Patent Application Ser. No. 63/171,533, filed on Apr. 6, 2021, U.S. Provisional Patent Application Ser. No. 63/209,932, filed on Jun. 11, 2021, and U.S. Provisional Patent Application Ser. No. 63/239,889, filed on Sep. 1, 2021, the contents of each of which are hereby incorporated by reference in their entirety.

### BACKGROUND

Software controllers are used in many applications, ranging from handheld devices to telecommunications networks. Software controllers are used instead of hardware controllers, such as dedicated circuitry, for many reasons, including the ability to update the software controller quickly, remotely, and/or without modifying the hardware being controlled. Software controllers are updated for many reasons, such as to add new functionality or to adapt to changes in usage, environment, etc. Sometimes a change in usage or environment causes a software controller to become ineffective, either because the software controller can no longer function at all, or because the software controller is effectively non-functional due to a severe reduction in efficiency or effectiveness. At other times, a change in usage or environment causes a software controller to have only mildly reduced efficiency or effectiveness.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a system for autonomous software controller adaptation, according to at least some embodiments of the present invention.

FIG. 2 is a schematic diagram of an apparatus for autonomous software controller adaptation, according to at least some embodiments of the present invention.

FIG. 3 is an operational flow for autonomous software controller adaptation, according to at least some embodiments of the present invention.

FIG. 4 is an operational flow for software controller generation, according to at least some embodiments of the present invention.

FIG. 5 is an operational flow for experiment application, according to at least some embodiments of the present invention.

FIG. 6 is an operational flow for candidacy evaluation, according to at least some embodiments of the present invention.

FIG. 7 is an operational flow for operating controller replacement, according to at least some embodiments of the present invention.

FIG. 8 is a block diagram of a hardware configuration for autonomous software controller adaptation, according to at least some embodiments of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

With the progression of digital transformation in telecommunication networks enabling practical and industrial realization of software controllers to manage the network, recent focus has turned towards the processes that will adapt these software controllers to changes in usage, environment, etc.

One form of such control is autonomous through continuous adaptation. Ideally, autonomous adaptation provides the capabilities to design, instantiate, monitor, operate, recover, heal, protect, optimize, and reconfigure software controllers without user intervention. Indeed, the interest in autonomous adaptation in telecommunications networks is currently so strong that 3GPP [3GPP TR 28.810], ETSI [ENI, ZSM], TMForum [catalyst], IRTF [ANIMA, NMRG], IEEE, ITU, and others have historic or ongoing initiatives under the description of some form of autonomy.

Many of these efforts manifest themselves in the application of various machine learning (ML) approaches to a single or a set of targeted use cases with the aim of automating the operations of management, reducing cost, optimizing resource usage, or automatically detecting or predicting unusual situations or circumstances.

A common problem in the application of ML to these use cases is the problem of model drift. Model drift is the phenomena whereby either the goal of the ML model changes overtime (conceptual drift) or when the available data no longer enables the model to form the same relationships (data drift). This problem is seen in financial markets, where market predictions are frequently revisited to address the reality that the operating environment (the market) has changed compared to when the model was made. Several tools and frameworks have been proposed to help address these issues.

ML is one enabling technology among many that can be utilized to achieve autonomous adaptation of the network. New software and hardware technology is created, updated, and deprecated, such as in O-RAN and ONAP. New services are introduced to the network and new ways of using the networks are emerging all the time. Definitions change, e.g.—what is good today is insufficient tomorrow.

As the operational environment and context of telecommunications networks change, so too the processes of control and adaptation that we use to operate the telecommunications network must change.

Closed-loop (CL) software control has become common in the approach taken to the automatic operation of networks. There are a range of different CL approaches in different domains: efficient and simple, strategic, tactical, centralized, distributed, intelligent, adaptative, hierarchical, etc.

Irrespective of the grouping or purpose, the logical concept of a CL is a self-contained entity with the ability to operate or monitor one or more managed entities. A CL is bound by the purpose for which the CL was designed, although some purposes include dynamic reflective capabilities.

Regardless of the domain of operation, technology, algorithm, intelligence, or data set used, an autonomous network will require the ability to adapt beyond pre-defined operational bounds not only in software controllers deployed to operate and manage the network but also in the process that it uses to generate such deployable software controllers.

As such, at least some embodiments described herein include a high-level architectural framework for autonomous networks based on the key concepts of exploratory evolution, real-time responsive online experimentation, and dynamic adaptation.

At least some embodiments described herein support the continuous evolutionary-driven creation, validation, and application of CL software controllers to a network and network services such that the network and its services may become autonomous.

In this way, traditional autonomic principles are attributed to the CL software controllers, which are applied to the network and network services, and the responsibility for adaptation of software controllers themselves over time lies with at least some architectures described herein. At least some embodiments described herein embrace this partition of concerns to enable the complimentary efforts in standards and research for CL, ML, and the general area of network management in the pursuit of autonomous networks.

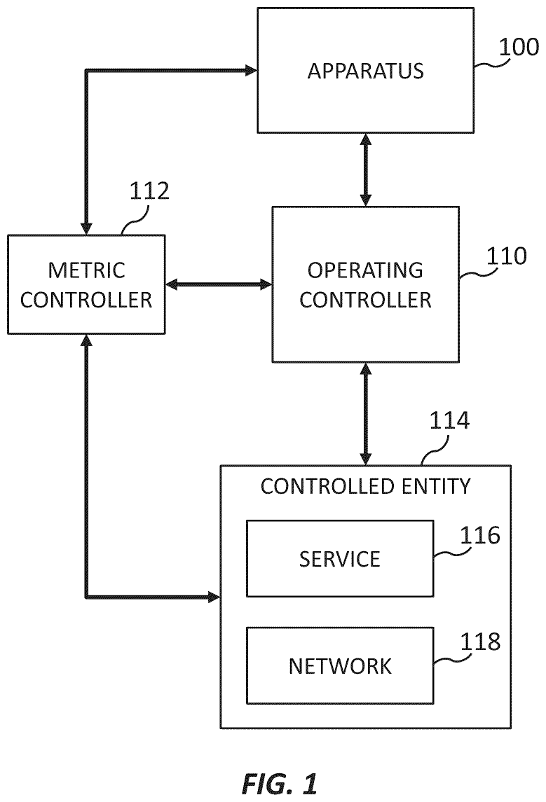

FIG. 1 is a block diagram of a system for autonomous software controller adaptation, according to at least some embodiments of the present invention. The system includes an apparatus 100, an operating controller 110, a metric controller 112, and a controlled entity 114.

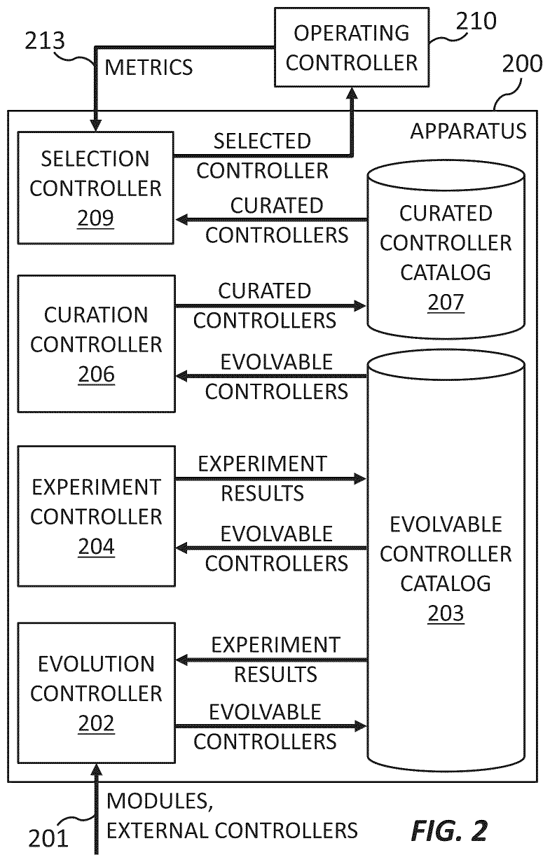

Apparatus 100 is in communication with operating controller 110 and metric controller 112. In at least some embodiments, apparatus 100 is configured to perform autonomous software controller adaptation. In at least some embodiments, apparatus 100 is configured to replace operating controller 110 with a selected candidate controller in response to a predetermined condition. In at least some embodiments, apparatus 100 is configured to generate software controllers according to the controller specification of operating controller 110, apply experiments to the generated software controllers for validation, curate validated software controllers to indicate some as candidate controllers, and select candidate controllers for replacement. In at least some embodiments, apparatus 100 includes a structure and function as described hereinafter with respect to FIG. 2.

Operating controller 110 is a software controller that performs closed-loop control of controlled entity 114 or a portion thereof, such as a service 116 or a network 118. In at least some embodiments, operating controller 110 manages a telecommunications network or a portion thereof. In at least some embodiments, operating controller 110 is a software controller of an Open Radio Access Network (O-RAN) module, such as a Central Unit (CU), a Distributed Unit (DU), or a Radio Unit (RU). In at least some embodiments, operating controller 110 is a software controller of a module in an edge server of a Content Distribution Network (CDN). In at least some embodiments, operating controller 110 is a software controller of a portable device, or a portion thereof, such as a notebook computer, smartphone, smartwatch, etc. In at least some embodiments, operating controller 110 is a software controller of an Internet-of-Things (IoT) device, such as a smart light bulb, smart refrigerator, etc. In at least some embodiments, operating controller 110 will internally process available information, make a decision, and generate a set of zero or more actions to be applied to controlled entity 114. In at least some embodiments, processing, decisions, and actions of operating controller 110 are based on the modules present within operating controller 110 as determined by the evolution process of apparatus 100. In at least some embodiments, operating controller 110 will implement the decided actions in the operational environment. In at least some embodiments, operating controller 110 will record its current utility, and other metrics to the knowledge store.

Controlled entity 114 is an electronic system or device at least a portion of which is under closed-loop control by operating controller 110. In at least some embodiments, controlled entity 114 is configured to transmit input data or values to operating controller 110, and receive instructions from operating controller 110. Controlled entity 114 includes service 116 and network 118. In at least some embodiments, controlled entity 114 is under closed-loop control by a plurality of operating controllers, including operating controller 110, each of the plurality of operating controllers performing closed-loop control of at least a portion of controlled entity 114. In at least some embodiments, each of the plurality of operating controllers is in communication with a separate and dedicated apparatus configured to replace the corresponding operating controller with a selected candidate controller. Controlled entity 114 is in communication with metric controller 112. In at least some embodiments, controlled entity 114 transmits metric values to metric controller 112 in response to requests from metric controller 112. In at least some embodiments, controlled entity 114 includes another operating controller, such as an operating controller within another system for autonomous software controller adaptation. In at least some embodiments, operating controller 110 is configured to decide the bounds of operation of the other operating controller.

Metric controller 112 is in communication with apparatus 100, operating controller 110, and controlled entity 114. In at least some embodiments, metric controller is configured to receive or retrieve metric values from controlled entity 114, and to transmit metric values to apparatus 100 and operating controller 110. In at least some embodiments, metric controller 112 is configured to process raw metric values received or retrieved from controlled entity 114, and transmit refined, aggregated, or statistical metric values to apparatus 100 and operating controller 110. In at least some embodiments, metrics include a controller utility and any other configurable information, such as operational context, ontological information, etc.

In at least some embodiments, the system does not include a metric controller, and instead the operations of the metric controller are performed by the other elements in FIG. 1. In at least some embodiments, the apparatus and the operating controller request or retrieve metric values directly from the controlled entity.

FIG. 2 is a schematic diagram of an apparatus 200 for autonomous software controller adaptation, according to at least some embodiments of the present invention. Apparatus 200 includes an evolution controller 202, an evolvable controller catalog 203, an experiment controller 204, a curation controller 206, a curated controller catalog 207, and a selection controller 209. In at least some embodiments, evolvable controller catalog 203 and curated controller 207 are in communication with apparatus 200 through a network.

Evolution controller 202 is configured to receive modules and external controllers 201, and to record evolvable controllers to evolvable controller catalog 203. In at least some embodiments, evolution controller 202 includes circuitry configured to generate a software controller by arranging a first sequence of modular functions according to a controller specification, the controller specification indicating a software controller input, a software controller output, and a utility function. In at least some embodiments, modules and external controllers 201 includes modular functions that are primitive, such as adding, multiplying, applying Boolean logic, or more advanced. In at least some embodiments, modules and external controllers 201 includes pre-arranged sequences of modular functions that perform a function similar to that of operating controller 210. In at least some embodiments, evolution controller 202 is configured to arrange new sequences of modular functions, to modify sequences of external controllers, or to modify sequences of evolvable controllers. In at least some embodiments, evolution controller 202 is configured to arrange sequences of modular functions similar to a process of genetic programming. In at least some embodiments, evolution controller 202 is configured to modify evolvable controllers according to experiment results. In at least some embodiments, evolution controller 202 is configured to retrieve experiment results from evolvable controller catalog 203. In at least some embodiments, evolution controller 202 is configured to continuously generate evolvable controllers.

Experiment controller 204 is configured to retrieve evolvable controllers from evolvable controller catalog 203, and to record experiment results to evolvable controller catalog 203. In at least some embodiments, experiment controller 204 includes circuitry configured to apply an experiment to the software controller to obtain a utility value. In at least some embodiments, experiment controller 204 is configured to apply an experiment to an evolvable controller while the evolvable controller processes input values to output values. In at least some embodiments, experiment controller 204 is configured to obtain utility metric values, from which a utility value can be derived upon application of a utility function. In at least some embodiments, experiment controller 204 is configured to obtain fitness metric values or other metric values, from which different evaluations are made. In at least some embodiments, experiment controller 204 is configured to apply an experiment to an evolvable controller while the evolvable controller processes input values to output values similar to a process of genetic programming. In at least some embodiments, the operations performed by evolution controller 202 and experiment controller 204 are substantially similar to the operations of genetic programming. In at least some embodiments, experiment controller 204 is configured to apply experiments beyond simply testing the utility function, as in genetic programming, including testing for fitness, environmental compatibility, etc.

Curation controller 206 is configured to retrieve evolvable controllers from evolvable controller catalog 203, and to record curated controllers to curated controller catalog 207. In at least some embodiments, curation controller 206 includes circuitry configured to indicate whether the software controller is a candidate controller for operation based on the utility value. In at least some embodiments, curation controller 206 is configured to compare evolvable controllers, their experiment results, and evaluation values to determine which evolvable controllers are appropriate candidates for replacing the operating controller. In at least some embodiments, curation controller 206 is configured to compare evolvable controllers for diversity, so that candidate controllers are not all the same sequence of modular functions, and include candidate controllers with different sequences of different modular functions. In at least some embodiments, curation controller 206 makes internal decisions on which of the candidate controllers present in candidate controller catalog 207 should be culled and which validated controllers should be added to candidate controller catalog 207.

Selection controller 209 is configured to retrieve curated controllers from curated controller catalog 207, and to select a candidate controller from among curated controllers to replace operating controller 210. In at least some embodiments, selection controller 209 includes circuitry configured to replace an operating controller with the candidate controller in response to a condition for replacing the operating controller being satisfied. In at least some embodiments, selection controller 209 is configured to detect conditions for replacing operating controller 210, and to select candidate controllers in response. In at least some embodiments, selection controller 209 is configured to receive metrics 213 from operating controller 210 to determine whether a replacement condition has been met. In at least some embodiments, selection controller 209 is configured to receive or retrieve metrics 213 from a metric controller, such as metric controller 112 of FIG. 1. In at least some embodiments, selection controller 209 is configured to apply the utility function according to the controller specification of operating controller 210 in order to monitor the utility value of operating controller 210 as operating controller 210 is in use processing input values to output values.

Evolvable controller catalog 203 stores evolvable controllers generated by evolution controller 202. Curated controller catalog 207 stores curated controllers indicated by curation controller 206 as candidates for replacing operating controller 210. In at least some embodiments, each of evolvable controller catalog 203 and curated controller catalog 207 are computer-readable storage mediums. In at least some embodiments, evolvable controller catalog 203 and curated controller catalog 207 are part of the same memory module of apparatus 200. In at least some embodiments, one or both of evolvable controller catalog 203 and curated controller catalog 207 are in communication with apparatus 200 through a network. In at least some embodiments, one or both of evolvable controller catalog 203 and curated controller catalog 207 include portions of multiple memory modules of apparatus 200, a cloud-based storage environment in communication with apparatus 200 through a network, or any other form a distributed storage.

In at least some embodiments, apparatus 200 is part of a system for autonomous adaptation of a single operating controller. In at least some embodiments, apparatus 200 is part of a system for autonomous adaptation of multiple operating controllers. In at least some embodiments, a controller of apparatus 200 is the operating controller subject to autonomous adaptation by another apparatus for autonomous software controller adaptation.

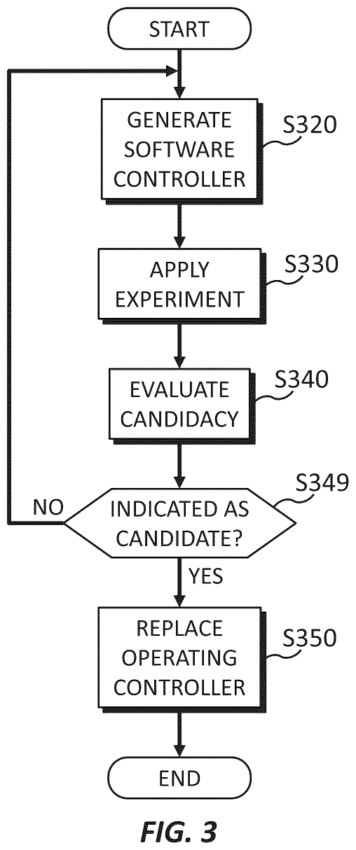

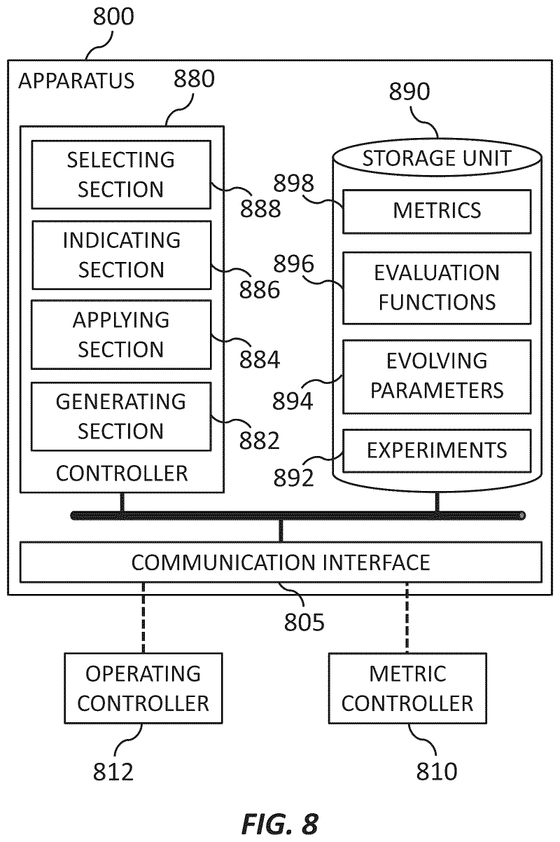

FIG. 3 is an operational flow for autonomous software controller adaptation, according to at least some embodiments of the present invention. The operational flow provides a method of autonomous software controller adaptation. In at least some embodiments, one or more operations of the method are executed by a controller of an apparatus including sections for performing certain operations, such as the controller and apparatus shown in FIG. 8, which will be explained hereinafter.

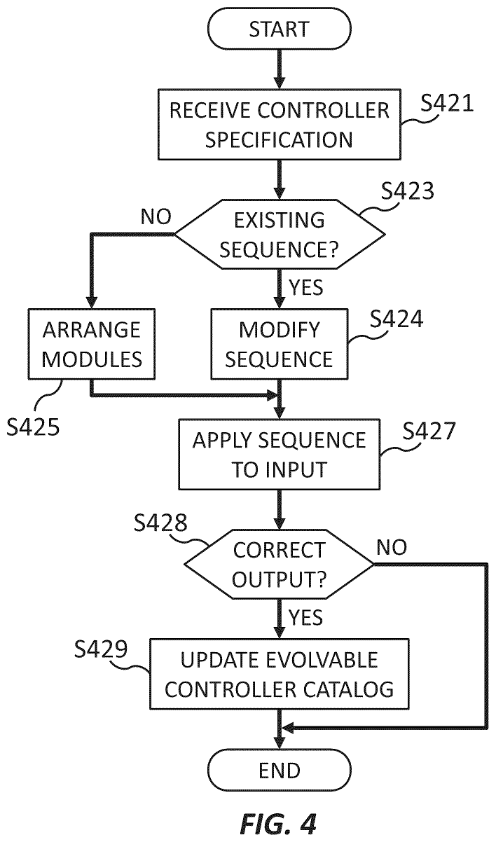

At S320, a generating section generates a software controller. In at least some embodiments, the generating section generates a software controller by arranging a first sequence of modular functions according to a controller specification, the controller specification indicating a software controller input, a software controller output, and a utility function. In at least some embodiments, the generating section arranges a new sequence of modular functions, modifies sequences of external controllers, or to modify sequences of evolvable controllers. In at least some embodiments, the generating section performs the software controller generation process described hereinafter with respect to FIG. 4.

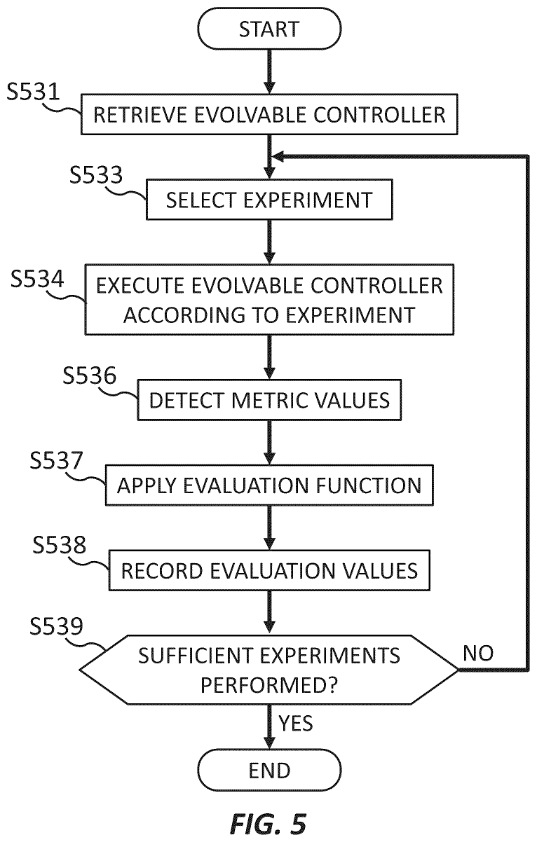

At S330, an applying section applies an experiment to the software controller. In at least some embodiments, the applying section applies an experiment to the software controller to obtain a utility value. In at least some embodiments, the applying section applies an experiment to an evolvable controller while the evolvable controller processes input values to output values. In at least some embodiments, the applying section performs the experiment application process described hereinafter with respect to FIG. 5. In at least some embodiments, the applying section applies experiments to validate the software controller. In at least some embodiments, the applying section designs, orchestrates, and executes an experimental process consisting of multiple stages assembled either a priori or on demand for the purpose of ensuring that the software controller can be shown to be “valid” or “fit for purpose”. In at least some embodiments, validation is a spectrum of activities that encompass static testing, simulation, testbed deployment, canary testing, digital twin, federated testbed, and production deployment.

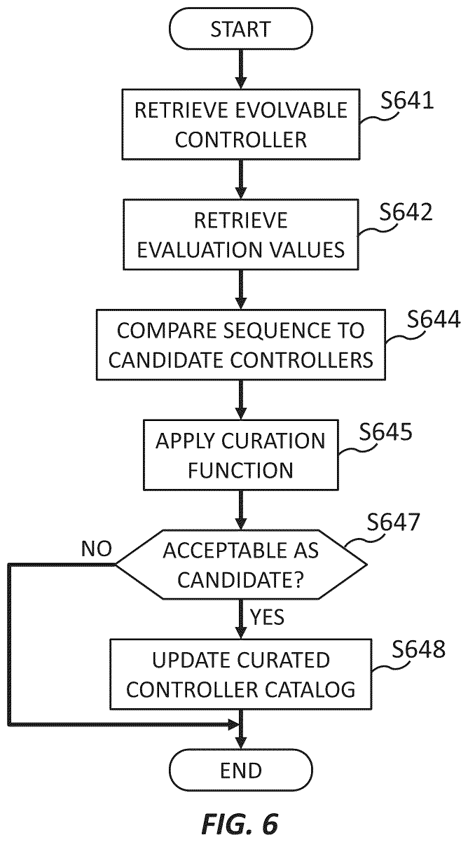

At S340, an indicating section evaluates candidacy of the software controller. In at least some embodiments, the indicating section indicates whether the software controller is a candidate controller for operation based on the utility value. In at least some embodiments, the indicating section compares the software controller to other evolvable controllers, their experiment results, and evaluation values to determine whether the software controller is an appropriate candidate for replacing the operating controller. In at least some embodiments, the indicating section performs the candidacy evaluation process described hereinafter with respect to FIG. 6.

At S349, the controller or a section thereof determines whether the software controller has been indicated as a candidate controller. If the controller determines that the software controller has not been indicated as a candidate controller, then the operational flow returns to software controller generation at S320. If the controller determines that the software controller has been indicated as a candidate controller, then the operational flow proceeds to operating controller replacement at S350.

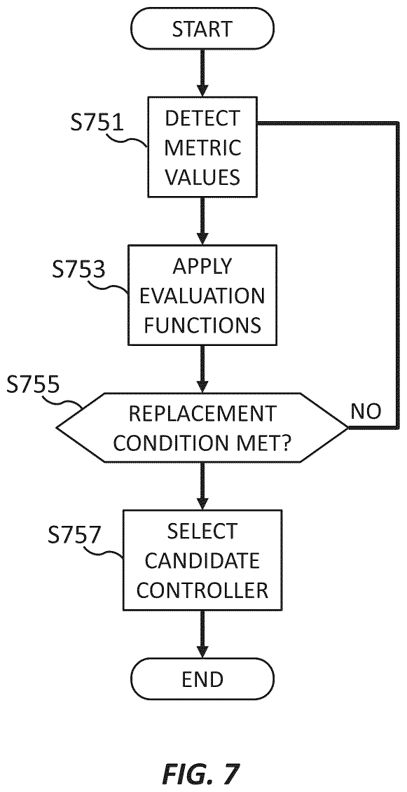

At S350, a selecting section replaces the operating controller with the software controller indicated as a candidate controller. In at least some embodiments, the selecting section replaces an operating controller with the candidate controller in response to a condition for replacing the operating controller being satisfied. In at least some embodiments, the selecting section detects a condition for replacing the operating controller, and selects a candidate controller in response. In at least some embodiments, the selecting section performs the operating controller replacement process described hereinafter with respect to FIG. 7.

In at least some embodiments, the operational flow for autonomous software controller adaptation proceeds as shown in FIG. 3 for a given software controller. In at least some embodiments, the operations at S320, S330, S340, and S350 are being constantly performed by their respective sections for individual software controllers. For example, once the generating section generates a given software controller, and the operational flow proceeds to experiment application for that software controller, the generating section proceeds to generate the next software controller without waiting for a cue or notification from the indicating section. In at least some embodiments, the generating section, applying section, and indicating section process many software controllers, resulting in a diverse population of candidate controllers by the time the selecting section detects a replacement condition.

In at least some embodiments, there is a distinction made between the “front end” operation of replacing the operating controller, which are performed at runtime during execution, and the “back end” operations of generating, applying, and indicating, which are performed at design time, a time period that is before and/or during runtime. In at least some embodiments, this distinction is to account for the separation of purpose as well as the differing timescale.

In at least some embodiments, operations of generating, applying, and indicating software controllers is a time-consuming process that can potentially take days or more depending on the purpose of the software controller. The population-based AI approach used in at least some embodiments relies on the notion of meaningful emergent behavior through trial-and-error experimentation. In at least some embodiments, validation increases the stability of such an approach.

In at least some embodiments, the application and selection of candidate controllers to a service requires a stable set of functioning controllers which can respond correctly in sub-second timescales, depending on the service of the operating controller.

FIG. 4 is an operational flow for software controller generation, according to at least some embodiments of the present invention. The operational flow provides a method of software controller generation. In at least some embodiments, one or more operations of the method are executed by a generating section of an apparatus, such as the apparatus shown in FIG. 8, which will be explained hereinafter.

At S421, the generating section or a sub-section thereof receives a controller specification. In at least some embodiments, the generating section receives a controller specification that indicates a software controller input, a software controller output, and a utility function. In at least some embodiments, the generating section receives a controller specification along with one or more existing sequences, such as pre-arranged external controller, or a previously generated evolvable controller.

At S423, the generating section determines whether the generating section is arranging a new sequence or modifying an arrangement of an existing sequence. In at least some embodiments, the generating section modifies existing sequences in response to a condition, such as a high diversity among candidate controllers, or a balance indicator between exploration and exploitation indicates that more exploitation is desired. In at least some embodiments, the generating section generates new sequences in response to a condition, such as a low diversity among candidate controllers, or a balance indicator between exploration and exploitation indicates that more exploration is desired. If the generating section determines to modify an arrangement of an existing sequence, then the operational flow proceeds to sequence manipulation at S424. If the generating section determines to arrange a new sequence, then the operational flow proceeds to module arrangement at S425.

At S424, the generating section or a sub-section thereof modifies the arrangement of modular functions of an existing sequence. In at least some embodiments, the arranging the sequence of modular functions includes modifying a second sequence of modular functions. In at least some embodiments, the generating section changes the order of modular functions, replaces a modular function with another modular function, adjusts values in the sequence, or any other genetic programming technique. In at least some embodiments, the generating section modifies the sequence based on one or more other sequences, such as crossover or mutation in the field of genetic programming. In at least some embodiments, the generating section modifies the arrangement by adjusting numerical or non-numerical parameters of individual modular functions without modifying the actual order. In at least some embodiments, the generating section generates more than one software controller as a result of modifying one sequence based on one or more other sequences.

At S425, the generating section or a sub-section thereof arranges modular functions into a new sequence. In at least some embodiments, the generating section arranges a sequence of modular functions capable of processing the software controller input values to the software controller output values according to the controller specification. In at least some embodiments, the generating section selects modular functions from among a plurality of diverse modular functions, each modular function having a primitive function or a more advanced function. In at least some embodiments, the generating section applies logic for connecting modular functions to compatible modular functions in sequence until the final modular function output is consistent with the controller specification. In at least some embodiments, the generating section selects modular functions according to the controller specification. If no modules are specified, the generating section requests all modular functions from a module repository. If modules are specified, the generating section requests the specified modules from the module repository. In at least some embodiments, depending on the controller specification and provided modular functions, either the generating section will attempt to randomly generate a set of legal software controllers from available modular functions in the module repository, such that any constraints specified in the controller specification are satisfied, or the generating section will attempt to generate a single legal software controller using only the modules specified in the controllers specification. In at least some embodiments, a legal software controller is a software controller which is well-formed, type safe, and structurally sound, but not necessarily capable of logically correct operation, which is assessed during experiment application.

At S427, the generating section or a sub-section thereof applies the sequence to software controller input according to the controller specification. In at least some embodiments, the generating section performs a simple test to determine whether or not the sequence is capable of processing input to output in accordance with the controller specification. In at least some embodiments, the generating section applies the sequence to test input associated with correct test output.

At S428, the generating section or a sub-section thereof determines whether the output from the sequence is correct. In at least some embodiments, the generating section determines whether the output matches correct test output or falls within a range of correct test output. If the generating section determines that the output from the sequence is correct, then the operational flow proceeds to evolvable controller catalog updating at S429. If the generating section determines that the output from the sequence is incorrect, then the operational flow ends.

At S429, the generating section or a sub-section thereof updates the evolvable controller catalog. In at least some embodiments, the generating section records the sequence to the evolvable controller catalog as an evolvable controller. In at least some embodiments, the generating section records multiple sequences to the evolvable controller catalog as evolvable controllers. In at least some embodiments, the generating section records the sequence to the evolvable controller catalog to replace an existing evolvable controller entry.

FIG. 5 is an operational flow for experiment application, according to at least some embodiments of the present invention. The operational flow provides a method of experiment application. In at least some embodiments, one or more operations of the method are executed by an applying section of an apparatus, such as the apparatus shown in FIG. 8, which will be explained hereinafter.

At S531, the applying section or a sub-section thereof retrieves an evolvable controller. In at least some embodiments, the applying section retrieves an evolvable controller from an evolvable controller catalog. In at least some embodiments the applying section retrieves or receives an evolvable controller from a generating section or an evolution controller.

At S533, the applying section or a sub-section thereof selects an experiment. In at least some embodiments, the applying section selects a basic experiment to test the utility of the evolvable controller. In at least some embodiments, the applying selects an experiment to test the fitness of the evolvable controller. In at least some embodiments, the applying selects an experiment to test whether the evolvable controller is compatible with an environment of a controlled entity. In at least some embodiments, the applying selects a canary test as an experiment, whereby the evolvable controller is rolled out into live operation in small quantities and/or for short periods of time. In at least some embodiments, the applying section designs and/or orchestrates an experimental process. In at least some embodiments, the applying section modifies an existing experimental process. As iterations of the operational flow proceed, the applying section sequentially selects experiments of a predetermined experiment set in at least some embodiments.

At S534, the applying section or a sub-section thereof executes the evolvable controller according to the selected experiment. In at least some embodiments, the applying section executes the evolvable controller to process input values into output values in accordance with the experiment.

At S536, the applying section or a sub-section thereof detects metric values. In at least some embodiments, the applying section detects a utility metric value from the software controller in response to applying the experiment. In at least some embodiments, the applying section detects the amount of time or energy required for the processing as metric values. In at least some embodiments, the applying section detects a fitness metric value from an environment in response to applying the experiment. In at least some embodiments, the applying section detects effects of the processing or application of the output as metric values.

At S537, the applying section or a sub-section thereof applies an evaluation function. In a least some embodiments, the applying section applies multiple evaluation functions to the detected metric values. In a least some embodiments, the applying section applies the utility function to the utility metric value to obtain the utility value. In a least some embodiments, the applying section applies a fitness function to the fitness metric value to obtain a fitness value.

At S538, the applying section or a sub-section thereof records the evaluation values. In at least some embodiments, the applying section records the evaluation values to the evolvable controller catalog in association with the retrieved evolvable controller. In at least some embodiments, the applying section records the evaluation values to a history of evaluation values in the evolvable controller catalog in association with the retrieved evolvable controller. In at least some embodiments, the applying section records controller failure, experimental failure, etc.

At S539, the applying section determines whether sufficient experiments have been performed. In at least some embodiments, the applying section determines whether all experiments of a predetermined experiment set have been performed. In at least some embodiments, the applying section determines whether a sufficient amount of total experiments or experiments of each type have been performed. If the applying section determines that sufficiency requires further experiments to be performed, then the operational flow returns to experiment selection at S533. If the applying section determines that sufficient experiments have been performed, then the operational flow ends.

FIG. 6 is an operational flow for candidacy evaluation, according to at least some embodiments of the present invention. The operational flow provides a method of candidacy evaluation. In at least some embodiments, one or more operations of the method are executed by an indicating section of an apparatus, such as the apparatus shown in FIG. 8, which will be explained hereinafter.

At S641, the indicating section or a sub-section thereof retrieves an evolvable controller. In at least some embodiments, the indicating section retrieves an evolvable controller from an evolvable controller catalog. In at least some embodiments the indicating section retrieves or receives an evolvable controller from an applying section or an experiment controller.

At S642, the indicating section or a sub-section thereof retrieves evaluation values associated with the evolvable controller. In at least some embodiments, the indicating section retrieves evaluation values from an evolvable controller catalog. In at least some embodiments the indicating section retrieves or receives evaluation values from an applying section or an experiment controller.

At S644, the indicating section or a sub-section thereof compares the sequence of modular functions to candidate controllers. In at least some embodiments, the indicating section compares the sequence to one or more candidate controllers to obtain at least one diversity value. In at least some embodiments, the indicating section compares the first sequence of modular functions to a third sequence of modular functions included in another candidate controller to obtain a diversity value. In at least some embodiments, the indicating section assigns values to each modular function in accordance with a spectrum, and then applies a distance function to the string of value assignments between the evolvable controller and the candidate controller. In at least some embodiments, the indicating section obtains a diversity value for each candidate controller, and then proceeds with the average or other statistical diversity value.

At S645, the indicating section or a sub-section thereof applies a curation function. In at least some embodiments, the indication section applies the curation function to the diversity value(s) and the evaluation values of the retrieved evolvable controller. In at least some embodiments, the indication section applies the curation function to determine whether to indicate that the retrieved evolvable controller is acceptable as a candidate. In at least some embodiments, the indicating section indicates that the software controller is a candidate controller for operation based on the utility value. In at least some embodiments, the indicating whether the software controller is a candidate controller for operation is further based on the fitness value. In at least some embodiments, the indicating whether the software controller is a candidate controller for operation is further based on the diversity value.

At S647, the indicating section determine whether the retrieved evolvable controller is acceptable as a candidate controller. If the indicating section determines that the retrieved evolvable controller is acceptable as a candidate controller, then the operational flow proceeds to curated controller catalog updating at S648. If the indicating section determines that the retrieved evolvable controller is acceptable as a candidate controller, then the operational flow ends.

At S648, the indicating section or a sub-section thereof updates the curated controller catalog. In at least some embodiments, the indicating section or a sub-section thereof records the evolvable controller to the curated controller catalog as a candidate controller. In at least some embodiments, the indicating section records the evolvable controller to the curated controller catalog to replace an existing candidate controller entry.

FIG. 7 is an operational flow for operating controller replacement, according to at least some embodiments of the present invention. The operational flow provides a method of operating controller replacement. In at least some embodiments, one or more operations of the method are executed by a selecting section of an apparatus, such as the apparatus shown in FIG. 8, which will be explained hereinafter.

At S751, the selecting section or a sub-section thereof detects metric values. In at least some embodiments, the selecting section detects metric values of an operating controller. In at least some embodiments, the selecting section detects metric values that are relevant to a utility function of the operating controller. In at least some embodiments, the selecting section detects metric values that are relevant to a fitness function of the operating controller. In at least some embodiments, detection of metrics is push-based, where the operating controller will periodically report utility and contextual information to the selecting section. In at least some embodiments, detection of metrics is pull-based, where the selecting section will request the operating controller to report utility and status information, the operating controller will reply to the selecting section with its current utility and status, and the selecting section will report the operating controller's utility and status to the indicating section.

At S753, the selecting section or a sub-section thereof applies evaluation functions to the detected metric values. In at least some embodiments, the selecting section applies the utility function to the metric values to obtain the current utility value. In at least some embodiments, the selecting section applies the utility function to the metric values to obtain the current fitness value.

At S755, the selecting section determines whether a replacement condition has been met. In at least some embodiments, the selecting section determines that a replacement condition has been met in response to the current utility value dropping below a threshold utility value. In at least some embodiments, the condition for replacing the operating controller includes the utility value falling below a utility threshold value, and the selecting section determines that a replacement condition has been met in response to the current fitness value dropping below a threshold fitness value. In at least some embodiments, the selecting section determines that a replacement condition has been met in response to applying an algorithm to the current utility value and the current fitness value. In at least some embodiments, the selecting section determines that a replacement condition has been met in response to the operating controller failing to perform. In at least some embodiments, the selecting section determines that a replacement condition has been met in response to an event unrelated to utility or fitness. If the selecting section determines that a replacement condition has been met, then the operational flow proceeds to candidate controller selection at S757. If the selecting section determines that a replacement condition has been met, then the operational flow returns to metric value detection at S751. As iterations of the operational flow proceed, the selecting section monitors the utility value of the operating controller.

At S757, the selecting section or a sub-section thereof selects a candidate controller. In at least some embodiments, the selecting section selects the candidate controller from among a plurality of candidate controllers, each candidate controller among the plurality of candidate controllers being a software controller indicated as a candidate controller for operation based on a corresponding utility value. In at least some embodiments, the selecting section selects the candidate controller based on a value associated with the candidate controller corresponding to the replacement condition that was met.

FIG. 8 is a block diagram of a hardware configuration for autonomous software controller adaptation, according to at least some embodiments of the present invention.

The exemplary hardware configuration includes apparatus 800, which interacts with operating controller 812, and communicates with metric controller 810. In at least some embodiments, apparatus 800 is integrated with operating controller 812. In at least some embodiments, apparatus 800 is a computer system that executes computer-readable instructions to perform operations for physical network function device access.

Apparatus 800 includes a controller 880, a storage unit 890, and a communication interface 805. In at least some embodiments, controller 880 includes a processor or programmable circuitry executing instructions to cause the processor or programmable circuitry to perform operations according to the instructions. In at least some embodiments, controller 880 includes analog or digital programmable circuitry, or any combination thereof. In at least some embodiments, controller 880 includes physically separated storage or circuitry that interacts through communication. In at least some embodiments, storage unit 890 includes a non-volatile computer-readable medium capable of storing executable and non-executable data for access by controller 880 during execution of the instructions. Communication interface 805 transmits and receives data from metric controller 810.

Controller 880 includes generating section 882, applying section 884, indicating section 886, and selecting section 888. Storage unit 890 includes experiments 892, evolving parameters 894, evaluation functions 896, and metrics 898.

Generating section 882 is the circuitry or instructions of controller 880 configured to generate software controllers. In at least some embodiments, generating section 882 is configured to generate a software controller by arranging a first sequence of modular functions according to a controller specification, the controller specification indicating a software controller input, a software controller output, and a utility function. In at least some embodiments, generating section 882 utilizes information in storage unit 890, such as evolving parameters 894. In at least some embodiments, generating section 882 includes sub-sections for performing additional functions, as described in the foregoing flow charts. In at least some embodiments, such sub-sections is referred to by a name associated with a corresponding function.

Applying section 884 is the circuitry or instructions of controller 880 configured to apply experiments. In at least some embodiments, applying section 884 is configured to apply experiments to software controllers to obtain utility values. In at least some embodiments, applying section 884 utilizes information in storage unit 890, such as experiments 892 and evaluation functions 896. In at least some embodiments, applying section 884 includes sub-sections for performing additional functions, as described in the foregoing flow charts. In at least some embodiments, such sub-sections is referred to by a name associated with a corresponding function.

Indicating section 886 is the circuitry or instructions of controller 880 configured to curate software controllers. In at least some embodiments, indicating section 886 is configured to indicate whether software controllers are candidate controllers based on the utility value. In at least some embodiments, indicating section 886 utilizes information from storage unit 890, such as evaluation functions 896. In at least some embodiments, indicating section 886 includes sub-sections for performing additional functions, as described in the foregoing flow charts. In at least some embodiments, such sub-sections is referred to by a name associated with a corresponding function.

Selecting section 888 is the circuitry or instructions of controller 880 configured to select candidate controllers to replace an operating controller. In at least some embodiments, selecting section 888 is configured to replace an operating controller with the candidate controller in response to a condition for replacing the operating controller being satisfied. In at least some embodiments, selecting section 888 utilizes information from storage unit 890, such as evaluation functions 896 and metrics 898. In at least some embodiments, indicating section 886 includes sub-sections for performing additional functions, as described in the foregoing flow charts. In at least some embodiments, such sub-sections is referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

According to at least some embodiments of the present invention, autonomous software controller adaptation is performed by generating a software controller by arranging a first sequence of modular functions according to a controller specification, the controller specification indicating a software controller input, a software controller output, and a utility function, applying an experiment to the software controller to obtain a utility value, indicating whether the software controller is a candidate controller for operation based on the utility value, and replacing an operating controller with the candidate controller in response to a condition for replacing the operating controller being satisfied.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions executable by a processor to cause the processor to perform operations comprising:
generating a software controller by arranging a first sequence of modular functions according to a controller specification, the controller specification indicating a software controller input, a software controller output, and a utility function;
applying an experiment to the software controller to obtain a utility value;
indicating whether the software controller is a candidate controller for operation based on the utility value; and
replacing an operating controller with the candidate controller in response to a condition for replacing the operating controller being satisfied.

2. The computer-readable medium of claim 1, wherein the arranging the sequence of modular functions includes:
modifying a second sequence of modular functions.

3. The computer-readable medium of claim 1, wherein the applying the experiment to the software controller includes:
detecting a utility metric value from the software controller in response to applying the experiment, and
applying the utility function to the utility metric value to obtain the utility value.

4. The computer-readable medium of claim 3, wherein
the applying the experiment to the software controller further includes:
detecting a fitness metric value from an environment in response to applying the experiment, and
applying a fitness function to the fitness metric value to obtain a fitness value, and
the indicating whether the software controller is a candidate controller for operation is further based on the fitness value.

5. The computer-readable medium of claim 1, wherein the operations further comprise:
monitoring the utility value of the operating controller;
wherein the condition for replacing the operating controller includes the utility value falling below a utility threshold value.

6. The computer-readable medium of claim 1, wherein the operations further comprise:
comparing the first sequence of modular functions to a third sequence of modular functions included in another candidate controller to obtain a diversity value;
wherein the indicating whether the software controller is a candidate controller for operation is further based on the diversity value.

7. The computer-readable medium of claim 1, wherein the replacing the operating controller includes:
selecting the candidate controller from among a plurality of candidate controllers, each candidate controller among the plurality of candidate controllers being a software controller indicated as a candidate controller for operation based on a corresponding utility value.

8. An apparatus comprising:
an evolution controller including circuitry configured to generate a software controller by arranging a first sequence of modular functions according to a controller specification, the controller specification indicating a software controller input, a software controller output, and a utility function;
an experiment controller including circuitry configured to apply an experiment to the software controller to obtain a utility value;
a curation controller including circuitry configured to indicate whether the software controller is a candidate controller for operation based on the utility value; and
a selection controller including circuitry configured to replace an operating controller with the candidate controller in response to a condition for replacing the operating controller being satisfied.

9. The apparatus of claim 8, wherein the evolution controller includes further circuitry configured to:
modify a second sequence of modular functions.

10. The apparatus of claim 8, wherein the experiment controller includes further circuitry configured to:
detect a utility metric value from the software controller in response to applying the experiment, and
apply the utility function to the utility metric value to obtain the utility value.

11. The apparatus of claim 10, wherein
the experiment controller includes further circuitry configured to
detect a fitness metric value from an environment in response to applying the experiment, and
apply a fitness function to the fitness metric value to obtain a fitness value, and
the curation controller includes further circuitry configured to indicate whether the software controller is a candidate controller for operation is further based on the fitness value.

12. The apparatus of claim 8, wherein the selection controller includes further circuitry configured to:
monitor the utility value of the operating controller;
wherein the condition for replacing the operating controller includes the utility value falling below a utility threshold value.

13. The apparatus of claim 8, wherein the curation controller includes further circuitry configured to:
compare the first sequence of modular functions to a third sequence of modular functions included in another candidate controller to obtain a diversity value;
wherein the curation controller includes further circuitry configured to indicate whether the software controller is a candidate controller for operation is further based on the diversity value.

14. A method comprising:
generating a software controller by arranging a first sequence of modular functions according to a controller specification, the controller specification indicating a software controller input, a software controller output, and a utility function;
applying an experiment to the software controller to obtain a utility value;
indicating whether the software controller is a candidate controller for operation based on the utility value; and
replacing an operating controller with the candidate controller in response to a condition for replacing the operating controller being satisfied.

15. The method of claim 14, wherein the arranging the sequence of modular functions includes:
modifying a second sequence of modular functions.

16. The method of claim 14, wherein the applying the experiment to the software controller includes:
detecting a utility metric value from the software controller in response to applying the experiment, and
applying the utility function to the utility metric value to obtain the utility value.

17. The method of claim 16, wherein
the applying the experiment to the software controller further includes
detecting a fitness metric value from an environment in response to applying the experiment, and
applying a fitness function to the fitness metric value to obtain a fitness value, and
the indicating whether the software controller is a candidate controller for operation is further based on the fitness value.

18. The method of claim 14, wherein the operations further comprise:
monitoring the utility value of the operating controller;
wherein the condition for replacing the operating controller includes the utility value falling below a utility threshold value.

19. The method of claim 14, wherein the operations further comprise:
comparing the first sequence of modular functions to a third sequence of modular functions included in another candidate controller to obtain a diversity value;
wherein the indicating whether the software controller is a candidate controller for operation is further based on the diversity value.

20. The method of claim 14, wherein the replacing the operating controller includes:
selecting the candidate controller from among a plurality of candidate controllers, each candidate controller among the plurality of candidate controllers being a software controller indicated as a candidate controller for operation based on a corresponding utility value.
